(19) United States
(12) Patent Application Publication
(10) Pub. No.: US 2022/0260716 A1
(43) Pub. Date: Aug. 18, 2022

(54) IMAGING DEVICES FOR CAPTURING COLOR AND DEPTH INFORMATION

(71) Applicant: SONY SEMICONDUCTOR SOLUTIONS CORPORATION, Kanagawa (JP)

(72) Inventors: Thomas Richard AYERS, Morgan Hill, CA (US); Ping Wah WONG, Sunnyvale, CA (US); Frederick BRADY, Webster, NY (US)

(73) Assignee: SONY SEMICONDUCTOR SOLUTIONS CORPORATION, Kanagawa (JP)

(21) Appl. No.: 17/610,766

(22) PCT Filed: May 21, 2020
(86) PCT No.: PCT/IB2020/000404

§ 371 Date: Nov. 12, 2021

Related U.S. Application Data
(60) Provisional application No. 62/850,915, filed on May 21, 2019.

(51) Int. Cl. G01S 17/89; G01S 7/481; G01B 11/22

(52) U.S. Cl. CPC G01S 17/89; G01B 11/22; G01S 7/4816

(57) ABSTRACT

An imaging device includes a pixel array including a plurality of pixels. Each pixel includes a photoelectric conversion region that converts incident light into electric charge, and a first transfer transistor coupled to a first floating diffusion and the photoelectric conversion region. The imaging device includes a first driving circuit to control the plurality of pixels in an imaging mode to generate a color image, and a second driving circuit to control the plurality of pixels in a depth mode to generate a depth image.

### FIELD

Example embodiments are directed to imaging devices, imaging apparatuses, and methods for operating the same, and more particularly, to imaging devices, imaging apparatuses, and methods for capturing color and depth information.

### BACKGROUND

Imaging sensing has applications in many fields, including object tracking, environment rendering, etc. Some image sensors employ time-of-flight (ToF) principles to detect a distance to an object or objects within a scene. In general, a ToF depth sensor includes a light source and an imaging device including a plurality of pixels for sensing reflected light. In operation, the light source emits light (e.g., infrared light) toward an object or objects in the scene, and the pixels detect the light reflected from the object or objects. The elapsed time between the initial emission of the light and receipt of the reflected light by each pixel may correspond to a distance from the object or objects. Direct ToF imaging devices may measure the elapsed time itself to calculate the distance while indirect ToF imaging devices may measure the phase delay between the emitted light and the reflected light and translate the phase delay into a distance. The depth values of the pixels are then used by the imaging device to determine a distance to the object or objects, which may be used to create a three dimensional scene of the captured object or objects.

### SUMMARY

Example embodiments relate to imaging devices, imaging apparatuses, and methods thereof that enable capturing color and depth information using a same set of pixels.

At least one example embodiment is directed to an imaging device including a pixel array including a plurality of pixels. Each pixel includes a photoelectric conversion region that converts incident light into electric charge, and a first transfer transistor coupled to a first floating diffusion and the photoelectric conversion region. The imaging device includes a first driving circuit to control the plurality of pixels in an imaging mode to generate a color image, and a second driving circuit to control the plurality of pixels in a depth mode to generate a depth image.

According to at least one example embodiment, the imaging device includes a plurality of color filters that correspond to the plurality of pixels, and the plurality of color filters include red color filters, green color filters, blue color filters, and neutral color filters.

According to at least one example embodiment, the neutral color filters include white color filters, gray color filters, or black color filters.

According to at least one example embodiment, the imaging device includes an optical filter on the plurality of color filters and that passes visible light and selected wavelengths of infrared light.

According to at least one example embodiment, the optical filter blocks wavelengths of light between a wavelength of the visible light and a wavelength of the selected wavelengths of infrared light.

According to at least one example embodiment, the second driving circuit applies first, second, third, and fourth transfer signals to the first transfer transistor in first, second, third, and fourth frames, respectively, to generate a first pixel value for the first frame, a second pixel value for the second frame, a third pixel value for the third frame, and a fourth pixel value for the fourth frame. The first, second, third, and fourth pixel values are used to calculate a distance to an object.

According to at least one example embodiment, the first, second, third, and fourth transfer signals have respective phase shifts of 0 degrees, 180 degrees, 90 degrees, and 270 degrees compared to a driving signal of a light source that emits light toward the object.

According to at least one example embodiment, the first driving circuit controls the plurality of pixels to output color data for the color image in a fifth frame.

According to at least one example embodiment, the first driving circuit and the second driving circuit control the plurality of pixels through a same set of signal lines.

According to at least one example embodiment, the first driving circuit includes first switching circuitry to connect the set of signal lines to the plurality of pixels in the imaging mode and disconnect the set of signal lines from the plurality of pixels in the depth mode. The second driving circuit includes second switching circuitry to connect the set of signal lines to the plurality of pixels in the depth mode and to disconnect the set of signal lines from the plurality of pixels in the imaging mode.

According to at least one example embodiment, each pixel further comprises a second transfer transistor coupled to a second floating diffusion and the photoelectric conversion region.

According to at least one example embodiment, the second driving circuit applies a first transfer signal to the first transfer transistor of a first pixel during a first frame to generate a first pixel value, applies a second transfer signal to the second transfer transistor of the first pixel during the first frame to generate a second pixel value, applies a third transfer signal to the first transfer transistor of a second pixel during the first frame to generate a third pixel value, and applies a fourth transfer signal to the second transfer transistor of the second pixel during the first frame to generate a fourth pixel value. The first, second, third, and fourth pixel values are used to calculate a distance to an object.

According to at least one example embodiment, the first driving circuit controls the plurality of pixels to output color data for the color image in a second frame.

According to at least one example embodiment, the first, second, third, and fourth transfer signals have respective phase shifts of 0 degrees, 180 degrees, 90 degrees, and 270 degrees compared to a driving signal of a light source that emits light toward the object.

According to at least one example embodiment, the second driving circuit applies the second transfer signal to the first transfer transistor of the first pixel during a second frame to generate a fifth pixel value, applies the first transfer signal to the second transfer transistor of the first pixel during the second frame to generate a sixth pixel value, applies the fourth transfer signal to the first transfer transistor of the second pixel during the second frame to generate a seventh pixel value, and applies the third transfer signal to the second transfer transistor of the second pixel during the second frame to generate an eighth pixel value.

According to at least one example embodiment, the first, second, third, fourth, fifth, sixth, seventh, and eighth pixel values are used to cancel fixed pattern noise in a distance calculation to the object.

According to at least one example embodiment, the first driving circuit and the second driving circuit control the plurality of pixels through a same set of signal lines.

According to at least one example embodiment, the first driving circuit controls the plurality of pixels to output color data for the color image in a third frame.

At least one example embodiment is directed to a system including a light source that emits infrared light, and an imaging device that includes a pixel array including a plurality of pixels. Each pixel includes a photoelectric conversion region that converts incident light into electric charge, and a first transfer transistor coupled to a first floating diffusion and the photoelectric conversion region. The imaging device includes a first driving circuit to control the plurality of pixels in an imaging mode to generate a color image based on visible light received from a scene, and a second driving circuit to control the plurality of pixels in a depth mode to generate a depth image based on the infrared light reflected from the scene.

At least one example embodiment is directed to a method that includes driving, by a first driving circuit, a plurality of pixels in an imaging mode to generate a color image, and driving, by a second driving circuit, the plurality of pixels in a depth mode to generate a depth image. The first driving circuit and the second driving circuit drive the plurality of pixels through a same set of signal lines.

### BRIEF DESCRIPTION OF THE DRAWINGS

FIG. 1 is a block diagram of an imaging device according to at least one example embodiment.

FIG. 2 illustrates an example schematic of a pixel from FIG. 1 according to at least one example embodiment.

FIG. 3 illustrates an example pixel array having a color filter array (CFA) used to sense color information and depth information according to at least one example embodiment.

FIG. 4 illustrates an example diagram for capturing depth and color information using the CFA of FIG. 3 according to at least one example embodiment.

FIG. 5 illustrates example characteristics of an imaging device that includes the CFA of FIG. 3 according to at least one example embodiment.

FIG. 6 illustrates another example of a CFA according to at least one example embodiment.

FIG. 7 illustrates an example readout method for collecting color information and depth information according to at least one example embodiment.

FIG. 8 illustrates an example schematic of a pixel array for achieving the method of FIG. 7 according to at least one example embodiment.

FIG. 9 illustrates an example wiring layout for achieving the method of FIG. 7 according to at least one example embodiment.

FIG. 10 illustrates another example wiring layout for achieving the method of FIG. 7 according to at least one example embodiment.

FIG. 11 illustrates an example readout method for collecting color and depth information according to at least one example embodiment.

FIG. 12 illustrates further details of the example readout method in FIG. 11 according to at least one example embodiment.

FIG. 13 illustrates an example schematic for achieving the method of FIGS. 11 and 12 according to at least one example embodiment.

FIG. 14 illustrates an example wiring layout for the schematic in FIG. 13 according to at least one example embodiment.

FIG. 15 illustrates an example wiring layout for the schematic in FIG. 13 according to at least one example embodiment.

FIG. 16 illustrates an example read out method according to at least one example embodiment.

FIG. 17 illustrates further details of the example read out method in FIG. 16 according to at least one example embodiment.

FIG. 18 illustrates an example schematic for achieving the example method in FIGS. 16 and 17 according to at least one example embodiment.

FIG. 19 illustrates an example wiring layout for the schematic in FIG. 18 according to at least one example embodiment.

FIG. 20 illustrates an example wiring layout for the schematic in FIG. 18 according to at least one example embodiment.

FIG. 21 illustrates an example read out method according to at least one example embodiment.

FIG. 22 illustrates example circuitry and timing diagram for driving a light source that produces the reference optical signal used for collecting depth information according to at least one example embodiment.

FIG. 23 illustrates an example structure of a pixel array that includes pixels and an optical filter according to at least one example embodiment.

FIG. 24 illustrates example processing operations for removing infrared light during color processing of a color image obtain during an imaging mode according to at least one example embodiment.

FIG. 25 illustrates example equations for cancelling FPN offsets according to at least one example embodiment.

FIG. 26 is a block diagram illustrating an example of a ranging module with the ability to capture color information according to at least one example embodiment.

FIG. 27 is a diagram illustrating use examples of an imaging device according to at least one example embodiment.

### DETAILED DESCRIPTION

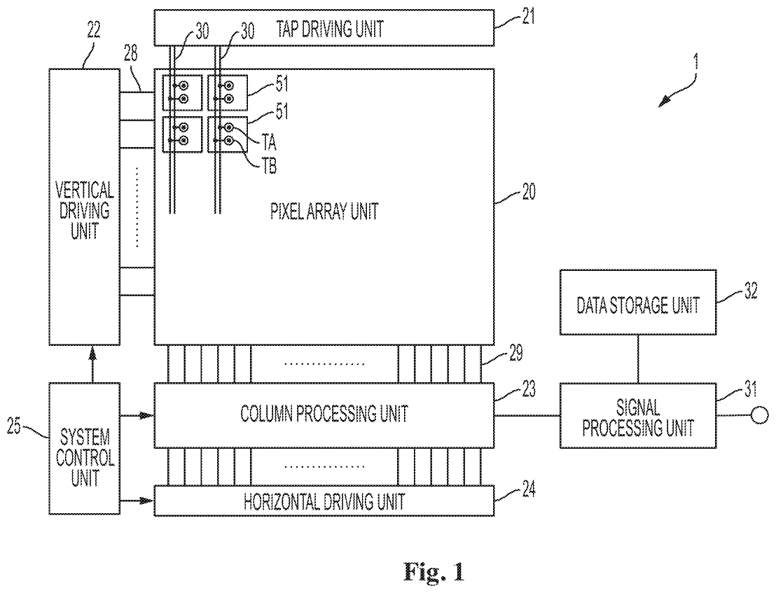

FIG. 1 is a block diagram of an imaging device according to at least one example embodiment.

The pixel 51 includes a photoelectric conversion region PD, such as a photodiode or other light sensor, transfer transistors TG0 and TG1, floating diffusion regions FD0 and FD1, reset transistors RST0 and RST1, amplification transistors AMP0 and AMP1, and selection transistors SEL0 and SEL1.

The imaging device 1 shown in FIG. 1 may be an imaging sensor of a front or rear surface irradiation type, and is provided, for example, in an imaging apparatus having a ranging function (or distance measuring function).

The imaging device 1 has a pixel array unit (or pixel array or pixel section) 20 formed on a semiconductor substrate (not shown) and a peripheral circuit integrated on the same semiconductor substrate the same as the pixel array unit 20. The peripheral circuit includes, for example, a tap driving unit (or tap driver) 21, a vertical driving unit (or vertical driver) 22, a column processing unit (or column processing circuit) 23, a horizontal driving unit (or horizontal driver) 24, and a system control unit (or system controller) 25.

The imaging device element 1 is further provided with a signal processing unit (or signal processor) 31 and a data storage unit (or data storage or memory or computer readable storage medium) 32. Note that the signal processing unit 31 and the data storage unit 32 may be mounted on the same substrate as the imaging device 1 or may be disposed on a substrate separate from the imaging device 1 in the imaging apparatus.

The pixel array unit 20 has a configuration in which pixels 51 that generate charge corresponding to a received light amount and output a signal corresponding to the charge are two-dimensionally disposed in a matrix shape of a row direction and a column direction. That is, the pixel array unit 20 has a plurality of pixels 51 that perform photoelectric conversion on incident light and output a signal corresponding to charge obtained as a result. Here, the row direction refers to an arrangement direction of the pixels 51 in a horizontal direction, and the column direction refers to the arrangement direction of the pixels 51 in a vertical direction. The row direction is a horizontal direction in the figure, and the column direction is a vertical direction in the figure.

The pixel 51 receives light incident from the external environment, for example, infrared light, performs photoelectric conversion on the received light, and outputs a pixel signal according to charge obtained as a result. The pixel 51 may include a first charge collector that detects charge obtained by the photoelectric conversion PD by applying a predetermined voltage (first voltage) to the pixel 51, and a second charge collector that detects charge obtained by the photoelectric conversion by applying a predetermined voltage (second voltage) to the pixel 51. The first and second charge collector may include tap A and tap B, respectively. Although two charge collectors are shown (i.e., tap A, and tap B), more or fewer charge collectors may be included according to design preferences. The first voltage and the second voltage assist with channeling charge toward tap A and tap B during different time periods. The charge is then read out of each tap A and B with transfer signals, discussed in more detail below.

The tap driving unit 21 supplies the predetermined first voltage to the first charge collector of each of the pixels 51 of the pixel array unit 20 through a predetermined voltage supply line 30, and supplies the predetermined second voltage to the second charge collector thereof through the predetermined voltage supply line 30. Therefore, two voltage supply lines 30 including the voltage supply line 30 that transmits the first voltage and the voltage supply line 30 that transmits the second voltage are wired to one pixel column of the pixel array unit 20.

In the pixel array unit 20, with respect to the pixel array of the matrix shape, a pixel drive line 28 is wired along a row direction for each pixel row, and two vertical signal lines 29 are wired along a column direction for each pixel column. For example, the pixel drive line 28 transmits a drive signal for driving when reading a signal from the pixel. Note that, although FIG. 1 shows one wire for the pixel drive line 28, the pixel drive line 28 is not limited to one. One end of the pixel drive line 28 is connected to an output end corresponding to each row of the vertical driving unit 22.

The vertical driving unit 22 includes a shift register, an address decoder, or the like. The vertical driving unit 22 drives each pixel of all pixels of the pixel array unit 20 at the same time, or in row units, or the like. That is, the vertical driving unit 22 includes a driving unit that controls operation of each pixel of the pixel array unit 20, together with the system control unit 25 that controls the vertical driving unit 22.

The signals output from each pixel 51 of a pixel row in response to drive control by the vertical driving unit 22 are input to the column processing unit 23 through the vertical signal line 29. The column processing unit 23 performs a predetermined signal process on the pixel signal output from each pixel 51 through the vertical signal line 29 and temporarily holds the pixel signal after the signal process.

Specifically, the column processing unit 23 performs a noise removal process, a sample and hold (S/H) process, an analog to digital (AD) conversion process, and the like as the signal process.

The horizontal driving unit 24 includes a shift register, an address decoder, or the like, and sequentially selects unit circuits corresponding to pixel columns of the column processing unit 23. The column processing unit 23 sequentially outputs the pixel signals obtained through the signal process for each unit circuit, by a selective scan by the horizontal driving unit 24.

The system control unit 25 includes a timing generator or the like that generates various timing signals and performs drive control on the tap driving unit 21, the vertical driving unit 22, the column processing unit 23, the horizontal driving unit 24, and the like, on the basis of the various generated timing signals.

The signal processing unit 31 has at least a calculation process function and performs various signal processing such as a calculation process on the basis of the pixel signal output from the column processing unit 23. The data storage unit 32 temporarily stores data necessary for the signal processing in the signal processing unit 31. The signal processing unit 31 may control overall functions of the imaging device 1. For example, the tap driving unit 21, the vertical driving unit 22, the column processing unit 23, the horizontal driving unit 24, and the system control unit 25, and the data storage unit 32 may be under control of the signal processing unit 31. The signal processing unit or signal processor 31, alone or in conjunction with the other elements of FIG. 1, may control all operations of the systems discussed in more detail below with reference to the accompanying figures. Thus, the terms “signal processing unit” and “signal processor” may also refer to a collection of elements 21, 22, 23, 24, 25, and/or 31. A signal processor according to at least one example embodiment is capable of processing color information to produce a color information and depth information to produce a depth image.

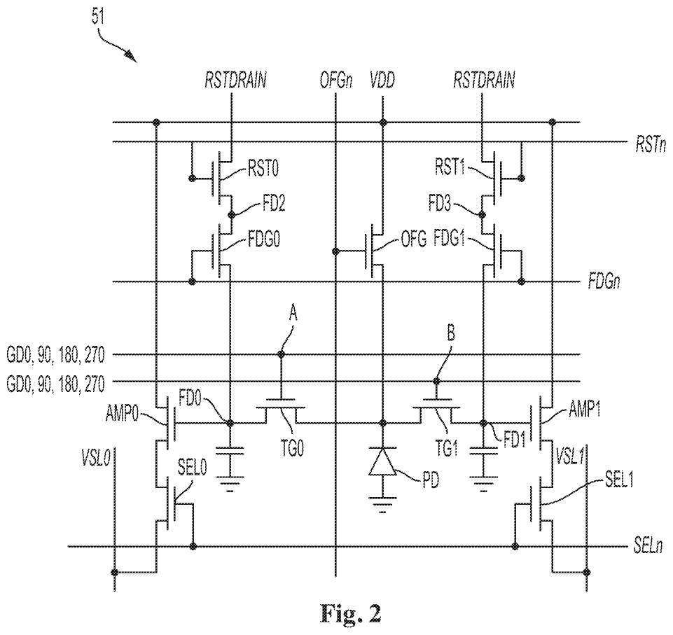

FIG. 2 illustrates an example schematic of a pixel 51 from FIG. 1. The pixel 51 includes a photoelectric conversion region PD, such as a photodiode or other light sensor, transfer transistors TG0 and TG1, floating diffusion regions FD0 and FD1, reset transistors RST0 and RST1, amplification transistors AMP0 and AMP1, and selection transistors SEL0 and SEL1. The pixel 51 may further include an overflow transistor OFG, transfer transistors FDG0 and FDG1, and floating diffusion regions FD2 and FD3.

The pixel 51 may be driven according to control signals or transfer signals GD0, GD90, GD180 and GD270 applied to gates or taps A/B of transfer transistors TG0/TG1, reset signal RSTDRAIN, overflow signal OFGn, power supply signal VDD, selection signal SELn, and vertical selection signals VSL0 and VSL1. These signals are provided by various elements from FIG. 1, for example, the tap driver 21, vertical driver 22, system controller 25, etc.

As shown in FIG. 2, the transfer transistors TG0 and TG1 are coupled to the photoelectric conversion region PD and have taps A/B that transfer charge as a result of applying transfer signals.

These transfer signals GD0, GD90, GD180, and GD270 may have different phases relative to a phase of a modulated signal from a light source (e.g., phases that differ 0 degrees, 90 degrees, 180 degrees, and/or 270 degrees). The transfer signals may be applied in a manner that allows for depth information (or pixel values) to be captured in a desired number of frames (e.g., one frame, two frames, four frames, etc.). One of ordinary skill in the art would understand how to apply the transfer signals in order to use the collected charge to calculate a distance to an object. In at least one example embodiment, other transfer signals may be applied in a manner that allows for color information to be captured for a color image.

It should be appreciated that the transfer transistors FDG0/FDG1 and floating diffusions FD2/FD3 are included to expand the charge capacity of the pixel 51, if desired. However, these elements may be omitted or not used, if desired. The overflow transistor OFG is included to transfer overflow charge from the photoelectric conversion region PD, but may be omitted or unused if desired. Further still, if only one tap is desired, then elements associated with the other tap may be unused or omitted (e.g., TG1, FD1, FDG1, RST1, SEL1, AMP1).

It should be understood that figures depicting pixel layouts discussed below show substantially accurate relative positional relationships of the elements depicted therein and can be relied upon as support for such positional relationships. For example, the figures provide support for selection transistors SEL and amplification transistors AMP being aligned with one another in a vertical direction. As another example, the figures provide support for an element on a right side of a figure being aligned with an element on a left side of a figure in the horizontal direction. As yet another example, the figures are generally accurate with respect to showing positions of overlapping elements.

In addition, where reference to general element or set of elements is appropriate instead of a specific element, the description may refer to the element or set of elements by its root term. For example, when reference to a specific transfer transistor TG0 or TG1 is not necessary, the description may refer to the transfer transistor(s) “TG.”

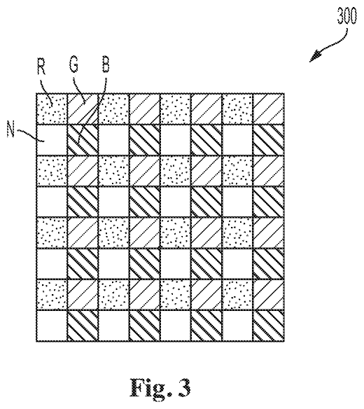

FIGS. 3-5 illustrate inventive concepts according to at least one example embodiment. In more detail, FIG. 3 illustrates an example pixel array 300 having a color filter array (CFA) used to sense color information and depth information. Each pixel in the pixel array may correspond to one of the pixels 51 above. As shown, the CFA uses red R, green G, and blue B color filters in a Bayer pattern, except that a subset of green color filters in the original Bayer pattern are neutral N (e.g., white) to detect infrared light to allow for a method that enables capture of color information and depth information by the pixel array. In order to allow for detection of infrared (IR) light, pixels with red, green, and blue color filters do not include an IR cut filter.

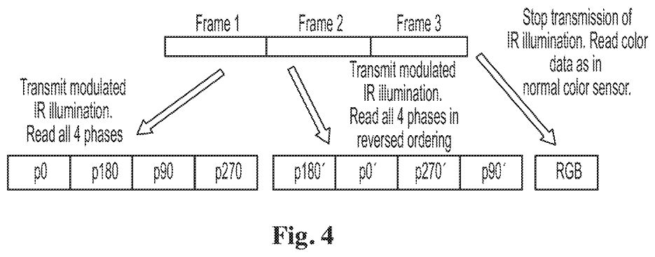

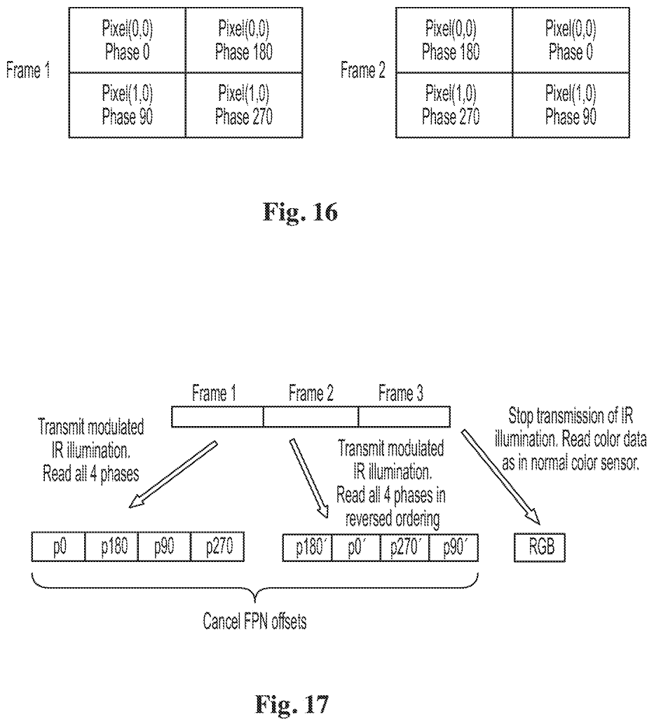

FIG. 4 illustrates an example diagram for capturing depth and color information using the CFA of FIG. 3. As shown for frames 1 and 2, a reference optical signal (e.g., modulated infrared IR light) may be emitted toward an object, and the reflected (IR) light signal cause charges to be generated in the photodiodes, where the charges are then transferred from respective photoelectric conversion regions of the pixels 51 to floating diffusions FD0/FD1 according to transfer signals GDA, GDB, GDC, GDD (e.g., applied to transfer transistors in the pixels) having the phases shown with respect to the reference optical signal. Throughout this description, GDA, GDB, GDC, and GDD correspond to GD0, GD90, GD180, and GD270 form FIG. 2, respectively. In frames 1 and 2, the transfer signals may be applied to taps (e.g., gates of transfer transistors) of pixels to transfer charge from respective photoelectric conversion regions, where the transfer signals are phase shifted 0, 90, 180, and 270 degrees from the reference optical signal. For example, in Frame 1, for pixels 51 with two taps which are identified by taps A and B, pixel signals or pixel values p0 and p90 may be associated with tap A, whereas pixel values p180 and p270 may be associated with tap B. In Frame 2, the transfer signals maybe applied to the taps of the pixels, where the transfer signals are phase shifted 180, 0, 270, and 90 degrees from the reference optical signal. For example, pixel values p180′ and p270′ may be associated with tap A, whereas pixel values p0′ and p90′ may be associated with tap B. FIGS. 16 and 17 describe FIG. 4 in more detail. In Frame 3, IR illumination is terminated and RGB data is read out in accordance with known techniques for the purpose of producing a color image.

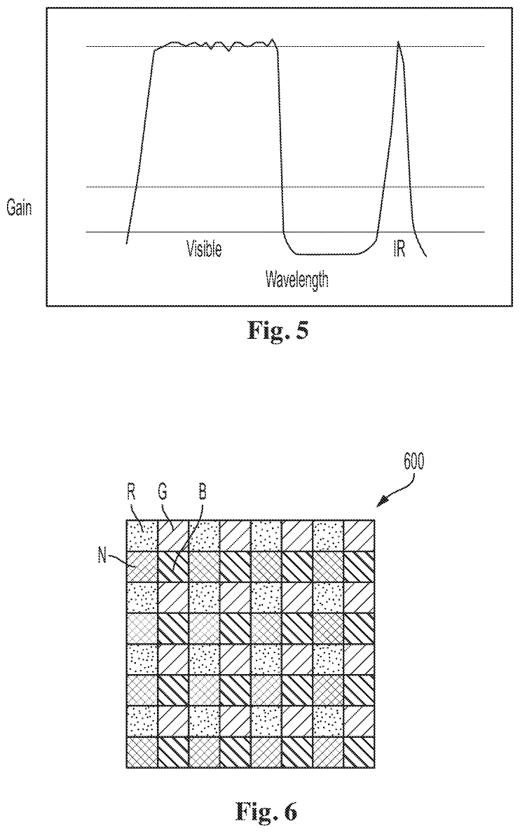

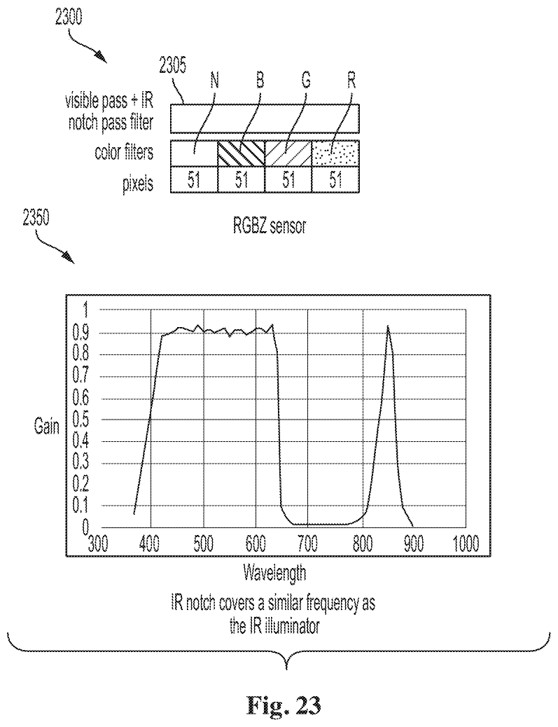

FIG. 5 illustrates example characteristics of an imaging device 1 that includes the CFA 300 of FIG. 3. As shown, an IR notch pass optical filter may be used in conjunction with the CFA 300 to pass most visible light, block certain wavelengths of light in the visible and IR spectrums, and pass certain wavelengths of IR light (see also FIG. 23).

FIG. 6 illustrates another example of a CFA 600 according to at least one example embodiment. The CFA 600 of FIG. 6 is a Bayer pattern except that a subset of the green color filters N in the original Bayer pattern are black or other neutral color (e.g., a shade of gray) that passes infrared light (e.g., due to reflections of the reference optical signal from an object). Although not explicitly shown, it should be understood that each color filter in the CFA 600 is associated with a pixel including a photoelectric conversion region and a plurality of transistors for reading out electric charge (e.g., transfer transistors, overflow transistors, selection transistors, amplification transistors, etc.). In addition, it should be understood that each color filter in the CFAs 300/600 shown in FIGS. 3 and 6 may be further divided into sub-filters that correspond to sub-pixels. For example, each color filter block may be divided into four, eight, or more, sub-blocks to further improve resolution of the imaging device 1.

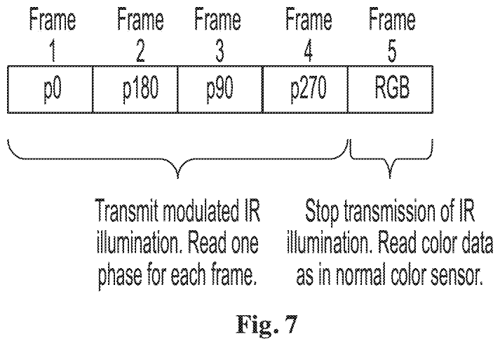

FIG. 7 illustrates an example readout method for collecting color information and depth information. As shown, Frames 1-4 may be used for reading out depth information by reading out electric charge as pixel values p0, p180, p90, p270 collected at 0, 180, 90, and 270 degrees phase shifts from the reference optical signal while Frame 5 is used to read out RGB color information. Each frame may comprise a desired number of modulation cycles where, for each modulation cycle, the light source emits a light signal and charge is detected with a transfer signal. The final pixel value (e.g., p0) for a particular phase may be the total amount of charge collecting for all modulation cycles in that frame. FIG. 7 illustrates an embodiment where only one tap per pixel is used to collect depth and color information. Accordingly, a pixel array configured to operate in accordance with FIG. 7 may not have the two tap per pixel configuration described with reference to FIGS. 1, 2 and 4, or one tap may be unused. Frames 1 thru 4 and 5 may be consecutive frames or frames may be skipped between each frame 1 thru 5 if desired.

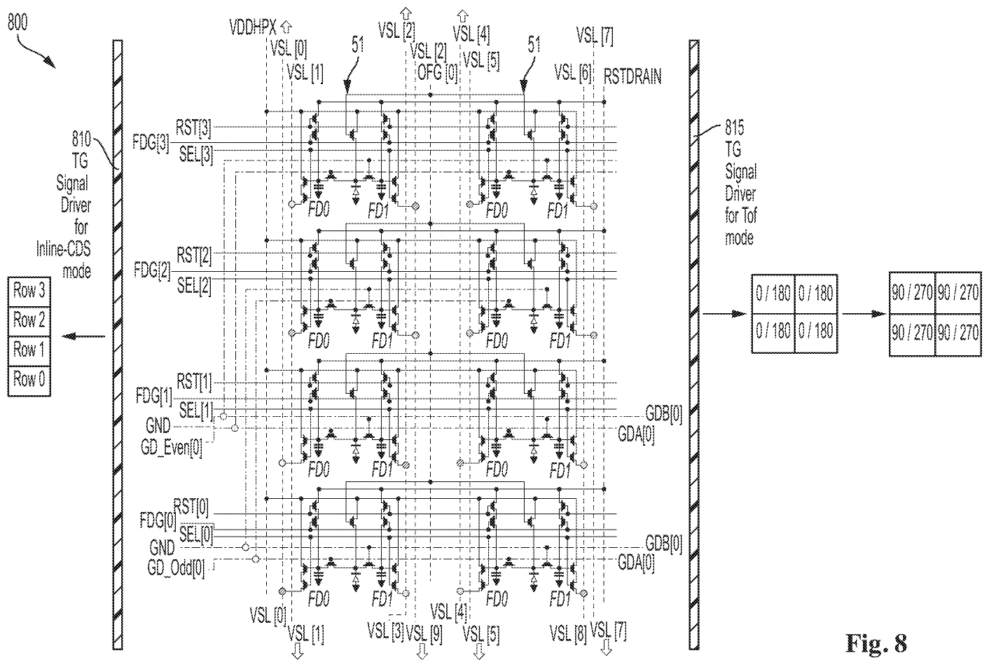

FIGS. 8-10 illustrate example structures for achieving the method of FIG. 7. As shown, the pixel array 800 in FIG. 8 may employ two drivers, an imaging driver (or driving circuit) 810 for driving the pixels 51 to collect color information in an imaging frame(s) and a depth driver (or driving circuit 815) for driving the pixels 51 to collect depth information in a depth frame(s). These drivers may be included in or separate from elements in FIG. 1. To collect color information, the imaging driver 810 may employ row by row control (row 3, row 2, row 1, row 0), while to collect depth information, the depth driver 815 may employ global control by applying transfer signals 0, 90, 180, and 270 degrees phase shifted from a light signal. FIG. 8 illustrates two groups of four blocks where each block represents a pixel. Each block is labeled with that pixel's associated phases 0/180 and 90/270. The notation 0/180 indicates that tap A of a pixel receives a transfer signal with 0 degrees phase difference from the light signal while tap B receives a transfer signal with 180 degrees phase difference from the light signal. The same is true for the notation 90/270 except the transfer signals are 90 degrees phase shifted and 270 degrees phase shifted. In general, each pixel 51 in FIG. 8 has the same or similar structure as the pixel of FIG. 2. FIG. 8 further illustrates various signal lines connected to the elements of each pixel. These signal lines include reset signal lines RST[0, 1, 2, 3,], vertical signal lines VSL[0, 1, 2, 3, 4, 5, 6, 7, 8, 9], transfer signal lines FDG [0, 1, 2, 3], transfer signal lines GDA[0], GDB[0] (with connections GD_Odd[0] to pixels in odd row numbers and GD_Even[0] to pixels in even row numbers), power signal lines VDDHPX and RSTDRAIN, ground signal lines GND to ground an unused tap (tap B in this example), and signal lines OFG connected to gates of overflow transistors OFG. In an imaging mode, imaging driver 810 may apply signals to these signal lines, while in a depth mode, the depth driver 815 may apply signals to the signal lines.

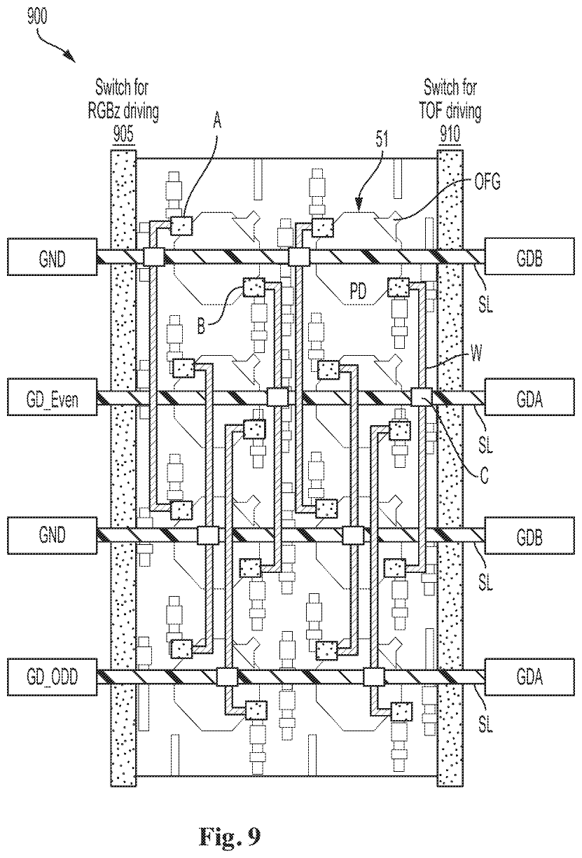

FIG. 9 illustrates an example wiring layout 900 where one control line drives transfer transistors in two rows. The photoelectric conversion regions PD are denoted by the octagonal shapes, and connections to transfer transistors TG0/TG1 are indicated by taps A and B. FIG. 9 shows switches 905 and 910 (which may be included in the drivers 810 and 815, respectively) for switching between an imaging mode and a depth mode at outer regions of the layout 900, wirings W, and connections C to wirings W. As shown, the wirings W connect signal lines SL (which correspond to signal lines from FIG. 8) to gates or taps AB of transistors TG0/TG1. The wirings W and connections C in FIG. 9 may be formed in a wiring layer of the imaging device (e.g., an M3 wiring layer), while the signal lines SL are formed in a different wiring layer. FIG. 9 further illustrates unlabeled transistors which correspond to transistors from FIG. 2. The photoelectric conversion regions PD, signal lines SL, wirings W, connections C, and transistors have the shown relative positional relationships. In general, the signal lines SL extend in a first direction (e.g., a horizontal direction) and are at arranged at regular intervals while the wirings W include portions that extend in the first direction and portions that extend in a second direction perpendicular to the first direction (e.g., a vertical direction).

To collect color information, only one of the transfer gates (e.g. TG0) or taps (A) is used, and the other transfer gate (e.g., TG1) or tap (B) is grounded with GND. In other words, a pixel in the imaging mode works similar to a pixel with a single transfer gate. However, example embodiments are not limited thereto, and the roles of TG0 and TG1 may be reversed if desired. That is, TG1 may be used to transfer signal in the imaging mode while TG0 is kept off. In any event, it should be understood that only one of the transfer transistors for each pixel 51 is used for transferring charge for color sensing.

To collect depth information, the odd rows may receive transfer signals at taps B and the even rows may receive transfer signals at taps A.

The transfer signals for collecting color and depth information may then be applied in accordance with FIG. 7. For example, in a first frame for charge transfer, the transfer signals applied to taps A may have a phase shift of 0 degrees compared to the reference optical signal. In a second frame for charge transfer, the transfer signals applied to taps A may have a phase shift of 180 degrees compared to the reference optical signal. In a third frame for charge transfer, the transfer signals applied to taps A may have a phase shift of 90 degrees compared to the reference optical signal. In a fourth frame, the transfer signals applied to taps A may have a phase shift of 270 degrees compared to the reference optical signal. In these four frames, tap B is pulsed with a signal having a 180 degree phase shift with respect to tap A. For example, in FIG. 8, if tap A is at 0 degrees, then tap B is at 180 degrees in the same frame; and if tap A is at 270 degrees, tap B is at 90 degrees in the same frame. In a fifth frame, the depth driver 815 is deactivated and the imaging driver 810 is activated to transfer charge used for generating color information by applying signals to signal lines GD_Even and GD_Odd. Thus, the charge collected by each FD is readout according to the diagram of FIG. 7.

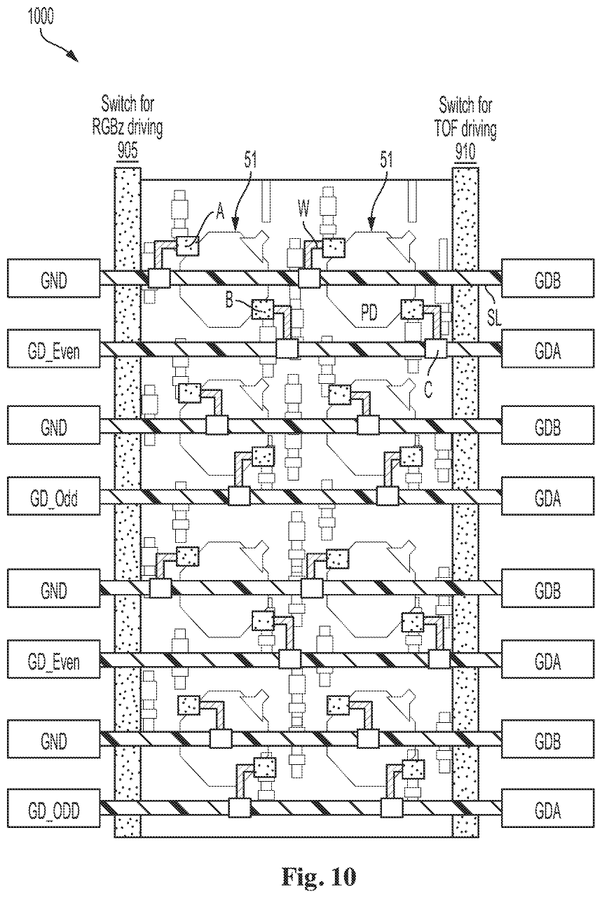

FIG. 10 illustrates another example wiring layout 1000 for achieving the readout method of FIG. 7. In FIG. 10, a single signal line SL drives one row of pixels 51, and the pixels 51 may be driven according the diagram of FIG. 7 as explained above with reference to FIG. 9. In FIG. 10, the photoelectric conversion regions PD, signal lines SL, wirings W, connections C, and transistors have the shown relative positional relationships. The signal lines SL may be arranged at regular intervals in two groups of four (i.e., a top group and a bottom group).

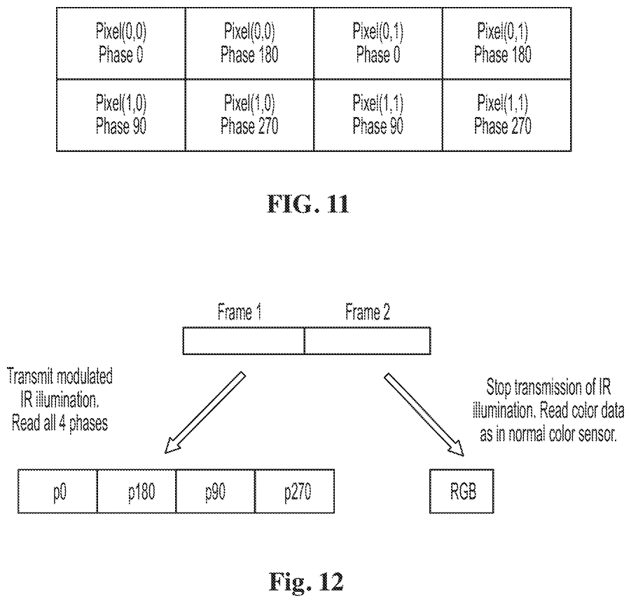

FIGS. 11 and 12 illustrate an example readout method for collecting color and depth information according to at least one example embodiment.

As shown in FIGS. 11 and 12, charge collected according to all four transfer signals is read out in a first frame while charge collected for color information is read out in a second frame. For example, in operation, pixel (0,0) has two taps A and B that transfer charge according to signals that are 0 and 180 degrees out of phase from the reference optical signal, while pixel (1,0) has two taps A and B that transfer charge according to signals that are 90 and 270 degrees out of phase with the reference optical signal. Pixel (0,1) is driven the same as pixel (0,0) and pixel (1,1) is driven the same as pixel (1,0). This allows a group of two pixels to collect charge as pixel values p0, p90, p180, and p270 for phases 0, 90, 180 and 270, which would be sufficient to do depth calculations in one frame. Although not explicitly shown, it should be understood that in another embodiment two phases may be read out in a first frame, two phases may be read out in a second frame, and the color information may be read out in a third frame.

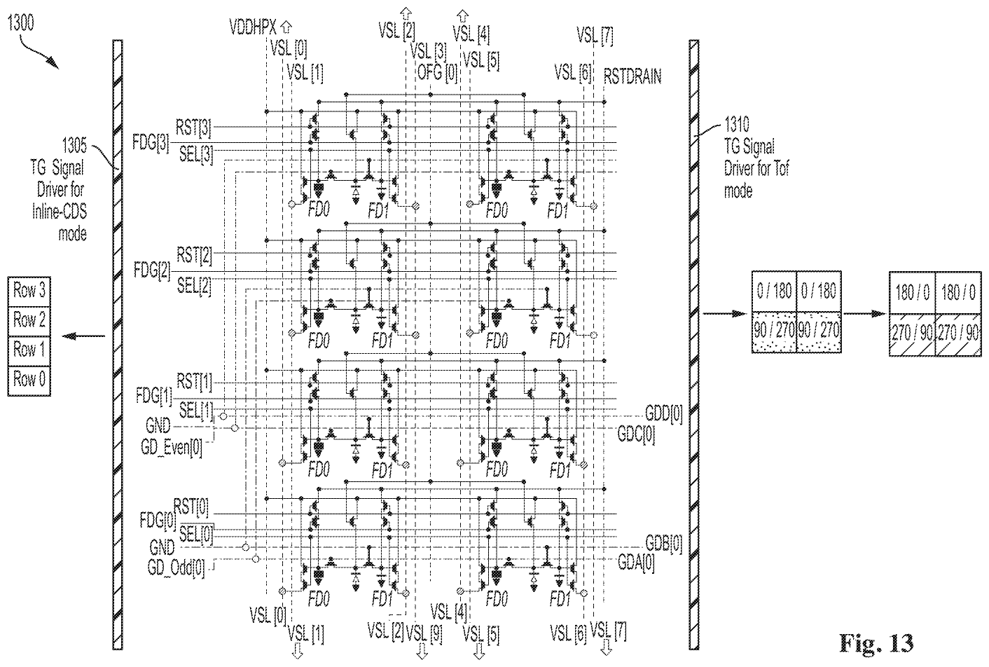

FIG. 13 illustrates an example schematic 1300 for achieving the method of FIGS. 11 and 12 and FIGS. 14-15 illustrates example wiring layouts for achieving the method of FIGS. 11 and 12. FIG. 13 illustrates a schematic having two drivers (or driving circuits) 1305 and 1310 as noted above with reference to FIG. 8. FIG. 13 includes many of the same elements as FIG. 8, and thus a description of these elements is not repeated. Compared to FIG. 8, FIG. 13 further includes signal lines GDC[0] and GDD[0] in order to carry out the method of FIGS. 11 and 12.

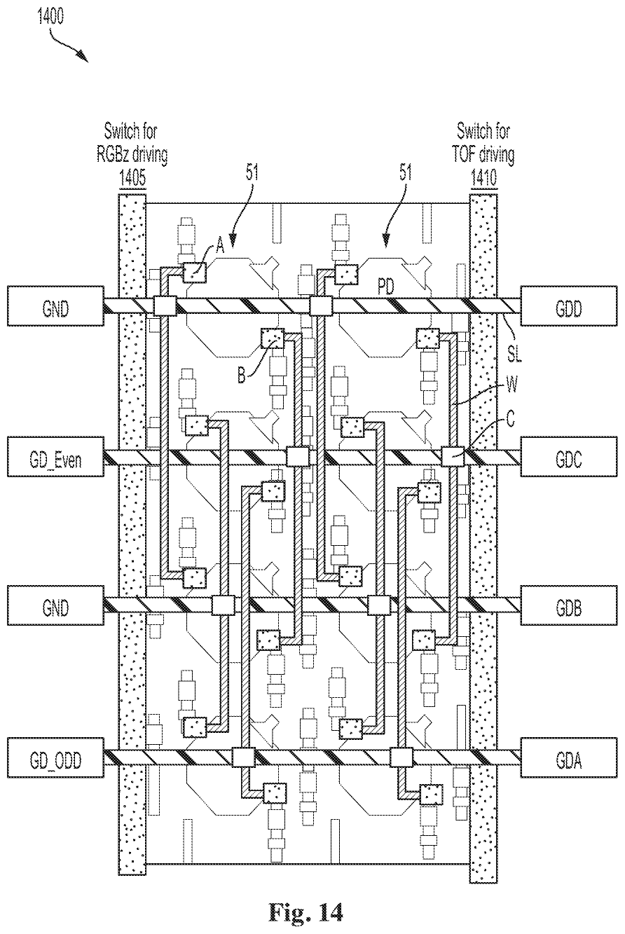

FIG. 14 illustrates an example wiring layout 1400 where one signal line SL controls two rows of pixels 51. To collect depth information, signal lines GND, GD_Even, and GD_Odd are driven in the same manner as note above in the description of FIG. 9. Meanwhile, to collect depth information, signal lines GDA, GDB, GDC, and GDD receive different transfer signals with different phases. For example, signal lines GDA, GDB, GDC, and GDD receive signals having 0, 180, 90, and 270 degrees phase shifts, respectively, compared to a reference optical signal. FIG. 14 includes switches 1405 and 1410, which are on or off depending on whether the imaging device is in a depth mode or an imaging mode. Each switch 1405/1410 may be included in a respective driving circuit 1305/1310. In FIG. 14, the photoelectric conversion regions PD, signal lines SL, wirings W, connections C, and transistors have the shown relative positional relationships. The signal lines SL may be arranged at regular intervals.

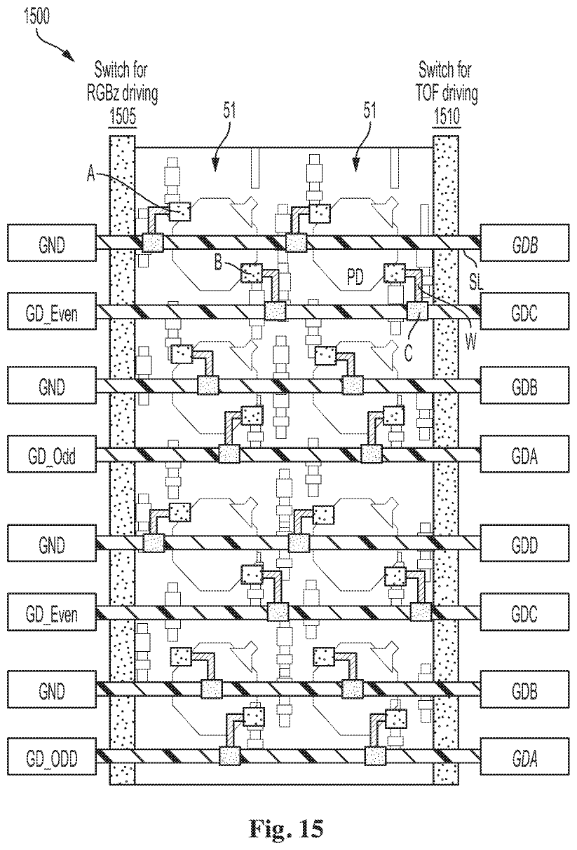

FIG. 15 illustrates an example wiring layout 1500 where one control line drives one row of pixels. In FIG. 15, the photoelectric conversion regions PD, signal lines SL, wirings W, connections C, and transistors have the shown relative positional relationships. The signal lines SL may be arranged at regular intervals in two groups of four (i.e., a top group and a bottom group).

FIGS. 16 and 17 illustrate an example read out method according to at least one example embodiment. A first Frame 1 may be the same as the first frame of FIG. 12 while in a second Frame 2 phases for taps A and B of the pixels 51 are inverted to collect pixel values p180′, p0′, p2′70′, and p90′. This method allows for cancellation of fixed pattern noise (FPN) offsets. Color information may be read out in a third Frame 3.

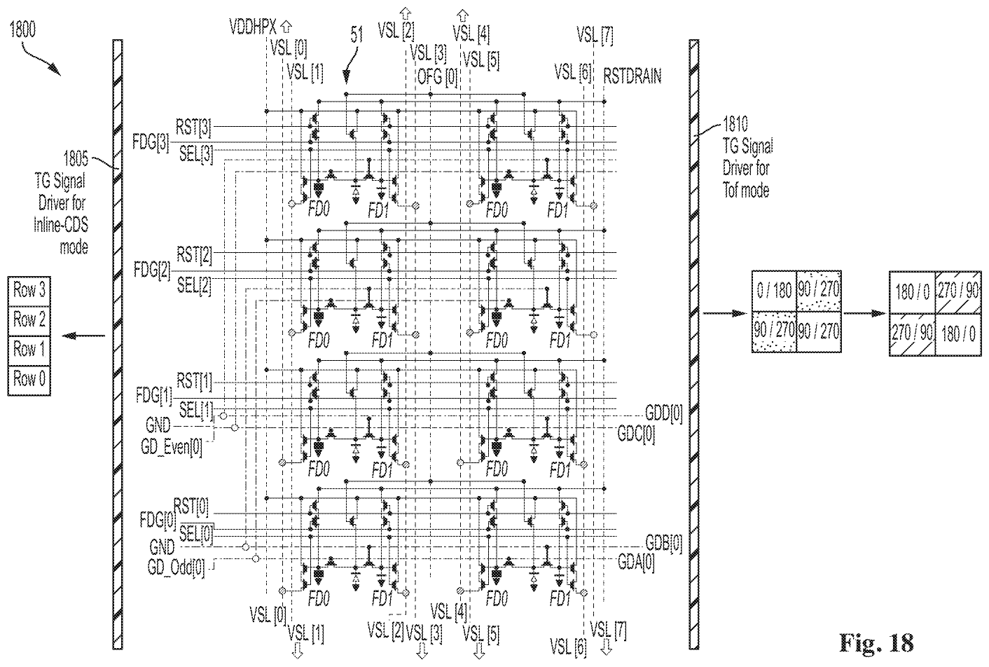

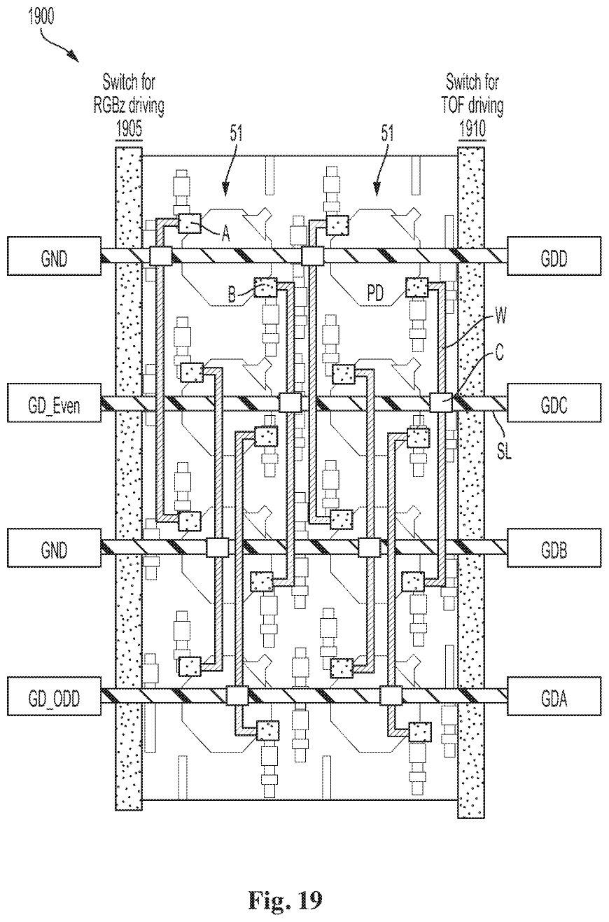

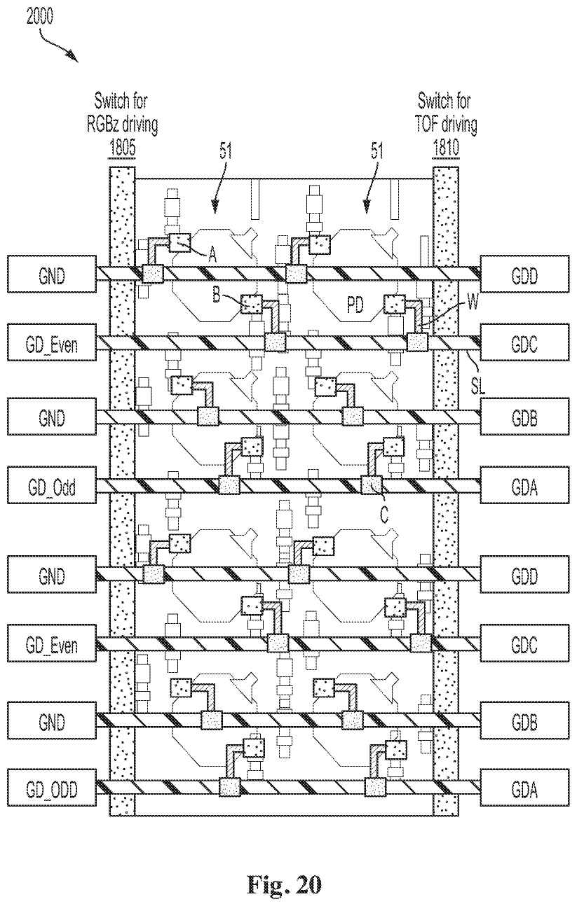

FIG. 18 illustrates a schematic 1800 for achieving the example method of FIGS. 16 and 17 while FIGS. 19 and 20 illustrate example wiring layouts 1900 and 2000 for the same. As in FIGS. 8 and 13, FIG. 18 shows an imaging driver 1805 for controlling readout of color information and a depth driver 1810 for controlling readout of depth information. FIG. 18 includes the same elements as FIG. 13, and thus a description of these elements is not repeated here.

As shown in FIG. 19, one signal line SL drives two pixel rows. As shown in FIG. 20, one signal line drives one row of pixels. To collect depth information, transfer signals are applied to the signal lines GDA, GDB, GDC, and GDD in a manner consistent with the method of FIGS. 16 and 17. To collect color information, transfer signals are applied to signal lines GND, GD_Even, and GD_Odd in the same manner as described above with reference to FIGS. 9, 10, and 14, and 15. FIG. 19 includes switches 1905 and 1910, which are on or off depending on whether the imaging device is in an imaging mode or a depth mode. In FIG. 19, the photoelectric conversion regions PD, signal lines SL, wirings W, connections C, and transistors have the shown relative positional relationships. The signal lines SL may be arranged at regular intervals.

In FIG. 20, the photoelectric conversion regions PD, signal lines SL, wirings W, connections C, and transistors have the shown relative positional relationships. The signal lines SL may be arranged at regular intervals in two groups of four (i.e., a top group and a bottom group).

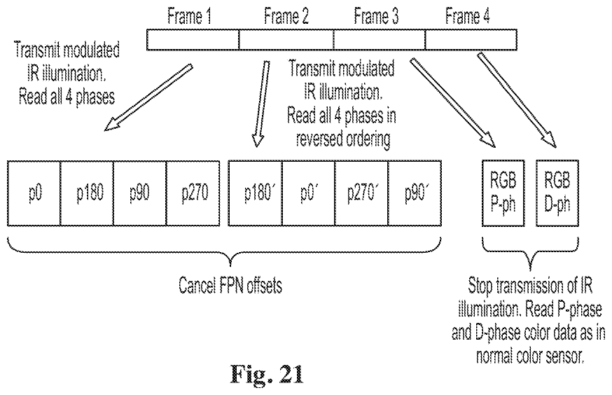

FIG. 21 illustrates an example read out method according to at least one example embodiment. FIG. 21 is the same as FIG. 17 except that FIG. 21 illustrates reading out P-phase and D-phase color data in third and fourth frames, respectively. Here, the P-phase may correspond to a frame when charge is collected during a reset operation in which the photoelectric conversion regions PD are reset, and the D-phase may correspond to a frame when charge is collected during an exposure period of the photoelectric conversion regions PD. The method of FIG. 21 may be carried out with the structures in FIGS. 18-20.

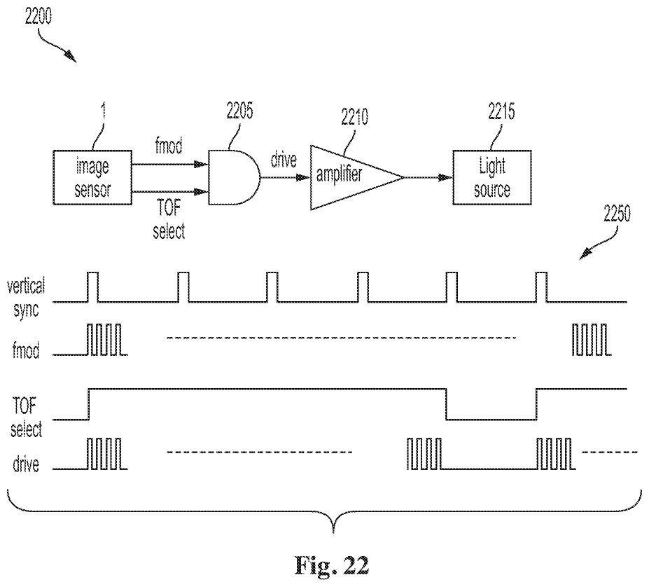

FIG. 22 illustrates example circuitry 2200 and timing diagram 2250 for driving a light source that produces the reference optical signal used for collecting depth information. As shown, circuitry 2200 may include the imaging device 1 (image sensor), a logic element 2205 (e.g., AND gate), an amplifier 2210, and a light source 2215. In operation, the imaging device 1 sends a modulated signal fmod and a selection signal TOF select to the logic element 2205 (and enter a depth mode) so that a drive signal of the logic element 2205 is fed to an amplifier which operates the light source 2215 accordingly. The timing diagram of FIG. 22 may be associated with example embodiments described with reference to FIGS. 7-10. In FIG. 22, the vertical synchronization signal controls the beginning and end of each frame.

FIG. 23 illustrates an example structure 2300 of a pixel array that includes pixels 51, corresponding color filters R, G, B, N and an optical filter 2305 that provides the filtering characteristics shown in the graph 2350. As shown, the optical filter 2350 passes wavelengths of visible and selected wavelengths of infrared light while blocking a section of wavelengths in between. The wavelengths of light emitted from the light source 2215 are selected to match the selected wavelengths of light passed by the optical filter 2305.

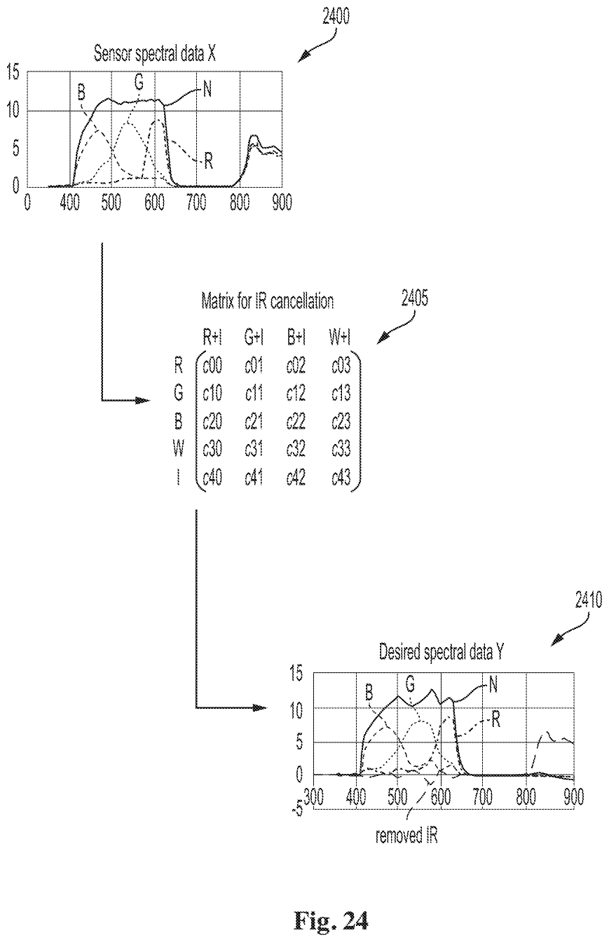

FIG. 24 illustrates example processing operations for removing infrared light during color processing of a color image obtain during an imaging mode. For example, FIG. 24 illustrates a graph 2400 that shows spectral data collected for R, G, B, and N pixels that includes IR light while graph 2410 shows desired spectral data with IR light removed. In FIG. 24, the neutral N pixel has a white color filter. FIG. 24 shows an example resultant matrix 2405 that is used for removing infrared light from the collected spectral data to arrive at the desired spectral data. Here, it should be appreciated that the matrix 2405 may vary according to the collected and desired spectral data. That is, given collected spectral data X and desired spectral data Y, the matrix 2405 is determined by minimizing a mean square error (MSE) of Y−X over a range of wavelengths.

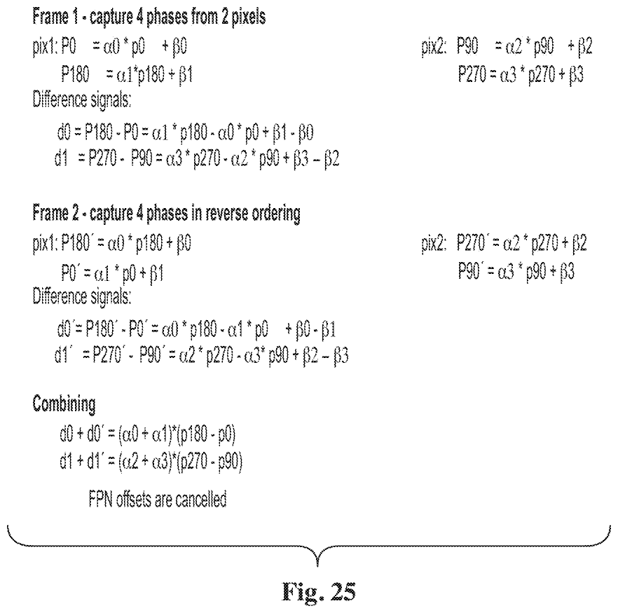

FIG. 25 illustrates example operations for cancelling FPN offsets during depth processing of a depth mode according to at least one example embodiment (e.g., for the read out methods of FIGS. 17 and 21). Here, the FPN offsets are represented as β0, β1, β2, and β3 while p0, p90, p180, and so on are pixel values associated with a particular phase. Further, α0, α1, α2, and α3 are fixed and/or variable values (e.g., caused by external conditions such as ambient light) that impact the pixel values. Difference signals are d0, d1, d0′, and d1′, which are differences between the shown pixel values. Upon combining difference signals d0 and d0′, and d1 and d1′, FPN offsets are cancelled. After FPN offsets are cancelled, the system may calculate a distance to an object using known methods (e.g., the arctangent method, two-four pulse ratio method, etc.). The arctangent set forth below with Equation (1):

$$Distance = \frac{C \cdot Δ T}{2} = \frac{C \cdot α}{4 π {f}_{m o d}} α = arctan ( \frac{{ϕ}_{1} - {ϕ}_{3}}{{ϕ}_{0} - {ϕ}_{2}} ) \qquad ( 1 )$$

Here, C is the speed of light, ΔT is the time delay, fmod is the modulation frequency of the emitted light, φ0 to φ3 are the signal values detected with transfer signals having phase differences from the emitted light 0 degrees, 90 degrees, 180 degrees, and 270 degrees, respectively.

Systems/devices that may incorporate the above described imaging devices will now be described.

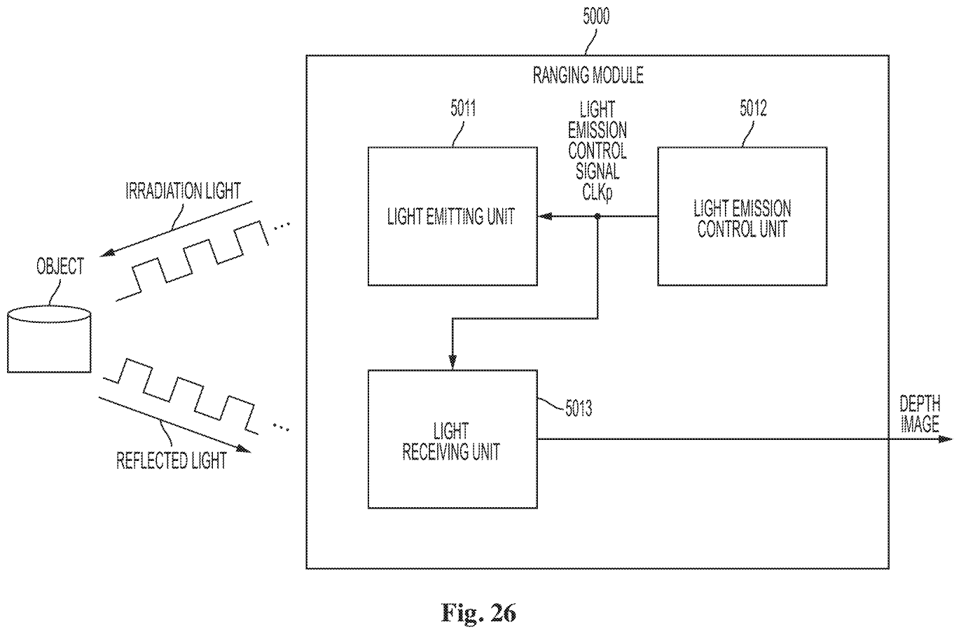

FIG. 26 is a block diagram illustrating an example of a ranging module with the ability to capture color information according to at least one example embodiment.

The ranging module 5000 includes a light emitting unit 5011, a light emission control unit 5012, and a light receiving unit 5013.

The light emitting unit 5011 has a light source that emits light having a predetermined wavelength, and irradiates the object with irradiation light of which brightness periodically changes. For example, the light emitting unit 5011 has a light emitting diode that emits infrared light having a wavelength in a range of 780 nm to 1000 nm as a light source, and generates the irradiation light in synchronization with a light emission control signal CLKp of a rectangular wave supplied from the light emission control unit 5012.

Note that, the light emission control signal CLKp is not limited to the rectangular wave as long as the control signal CLKp is a periodic signal. For example, the light emission control signal CLKp may be a sine wave.

The light emission control unit 5012 supplies the light emission control signal CLKp to the light emitting unit 5011 and the light receiving unit 5013 and controls an irradiation timing of the irradiation light. A frequency of the light emission control signal CLKp is, for example, 20 megahertz (MHz). Note that, the frequency of the light emission control signal CLKp is not limited to 20 megahertz (MHz), and may be 5 megahertz (MHz) or the like.

The light receiving unit 5013 receives reflected light reflected from the object, calculates the distance information for each pixel according to a light reception result, generates a depth image in which the distance to the object is represented by a gradation value for each pixel, and outputs the depth image.

The above-described imaging device 1 is used for the light receiving unit 5013, and for example, the imaging device 1 serving as the light receiving unit 5013 generates color images in an imaging mode and calculates the distance information for each pixel from a signal intensity detected by at least one of taps AB in a depth mode, on the basis of the light emission control signal CLKp.

As described above, the imaging device 1 shown in FIG. 1 is able to be incorporated as the light receiving unit 5013 of the ranging module 5000 that obtains and outputs the information associated with the distance to the subject by the indirect ToF method. By adopting the imaging device 1 of one or more of the embodiments described above, it is possible to improve one or more distance measurement characteristics of the ranging module 5000 (e.g., distance accuracy, speed of measurement, and/or the like).

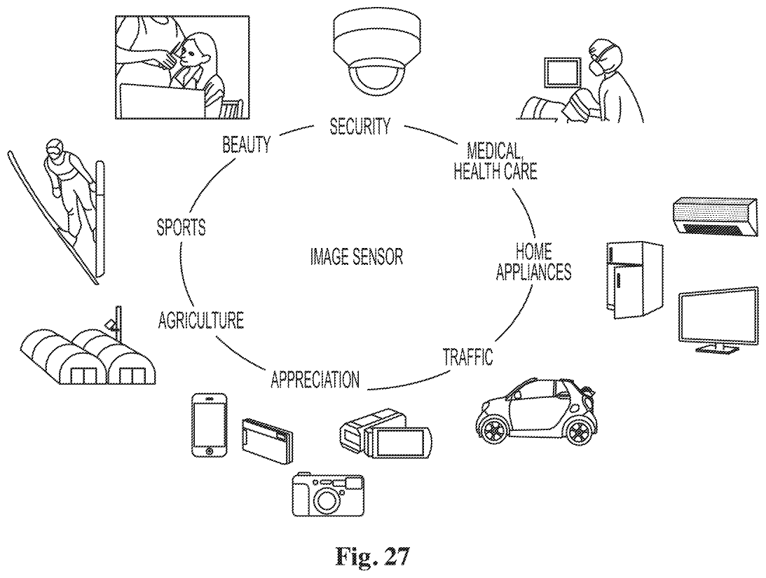

FIG. 27 is a diagram illustrating use examples of an imaging device 1 according to at least one example embodiment.

For example, the above-described imaging device 1 (image sensor) can be used in various cases of sensing light such as visible light, infrared light, ultraviolet light, and X-rays as described below. The imaging device 1 may be included in apparatuses such as a digital still camera and a portable device with a camera function which capture images, apparatuses for traffic such as an in-vehicle sensor that captures images of a vehicle to enable automatic stopping, recognition of a driver state, measuring distance, and the like. The imaging device 1 may be included in apparatuses for home appliances such as a TV, a refrigerator, and an air-conditioner in order to photograph a gesture of a user and to perform an apparatus operation in accordance with the gesture. The imaging device 1 may be included in apparatuses for medical or health care such as an endoscope and an apparatus that performs angiography through reception of infrared light. The imaging device 1 may be included in apparatuses for security such as a security monitoring camera and a personal authentication camera. The imaging device 1 may be included in an apparatus for beauty such as a skin measuring device that photographs skin. The imaging device 1 may be included in apparatuses for sports such as an action camera, a wearable camera for sports, and the like. The imaging device 1 may be included in apparatuses for agriculture such as a camera for monitoring a state of a farm or crop.

In view of the above, it should be appreciated that example embodiments provide the ability to capture both color and depth information using a same set of pixels. Example embodiments further provide for multiple readout methods to capture depth and color information in a desired number of frames, and methods for FPN cancellation and removal of IR signals from color information.

In view of FIGS. 1-27, at least one example embodiment is directed to an imaging device 1 including a pixel array including a plurality of pixels 51. Each pixel 51 includes a photoelectric conversion region PD that converts incident light into electric charge, and a first transfer transistor TG0 coupled to a first floating diffusion FD0 and the photoelectric conversion region PD. The imaging device 1 includes a first driving circuit 810/1305/1805 to control the plurality of pixels 51 in an imaging mode to generate a color image, and a second driving circuit 815/1310/1810 to control the plurality of pixels 51 in a depth mode to generate a depth image.

According to at least one example embodiment, the imaging device includes a plurality of color filters that correspond to the plurality of pixels 51, and the plurality of color filters include red color filters R, green color filters G, blue color filters B, and neutral color filters N.

According to at least one example embodiment, the neutral color filters N include white color filters, gray color filters, or black color filters.

According to at least one example embodiment, the imaging device 1 includes an optical filter 2305 on the plurality of color filters that passes visible light and selected wavelengths of infrared light.

According to at least one example embodiment, the optical filter 2305 blocks wavelengths of light between a wavelength of the visible light and a wavelength of the selected wavelengths of infrared light (see FIG. 23).

According to at least one example embodiment, the second driving circuit applies first, second, third, and fourth transfer signals GD0, GD180, GD90, and GD270 to the first transfer transistor TG0 in first, second, third, and fourth frames, respectively, to generate a first pixel value p0 for the first frame, a second pixel value p180 for the second frame, a third pixel value p90 for the third frame, and a fourth pixel value p270 for the fourth frame. The first, second, third, and fourth pixel values are used to calculate a distance to an object.

According to at least one example embodiment, the first, second, third, and fourth transfer signals have respective phase shifts of 0 degrees, 180 degrees, 90 degrees, and 270 degrees compared to a driving signal of a light source that emits light toward the object.

According to at least one example embodiment, the first driving circuit controls the plurality of pixels to output color data for the color image in a fifth frame (see FIG. 7, for example).

According to at least one example embodiment, the first driving circuit and the second driving circuit control the plurality of pixels 51 through a same set of signal lines SL (see FIG. 9, for example).

According to at least one example embodiment, the first driving circuit includes first switching circuitry 905/1405/1905 to connect the set of signal lines to the plurality of pixels in the imaging mode and disconnect the set of signal lines SL from the plurality of pixels 51 in the depth mode. The second driving circuit includes second switching circuitry 910/1410/1910 to connect the set of signal lines SL to the plurality of pixels 51 in the depth mode and to disconnect the set of signal lines SL from the plurality of pixels in the imaging mode.

According to at least one example embodiment, each pixel 51 further comprises a second transfer transistor TG1 coupled to a second floating diffusion FD1 and the photoelectric conversion region PD.

According to at least one example embodiment, the second driving circuit 815/1310/1810 applies a first transfer signal GD0 to the first transfer transistor TG0 of a first pixel during a first frame to generate a first pixel value p0, applies a second transfer signal GD180 to the second transfer transistor TG1 of the first pixel during the first frame to generate a second pixel p180 value, applies a third transfer signal GD90 to the first transfer transistor TG0 of a second pixel during the first frame to generate a third pixel value p90, and applies a fourth transfer signal GD270 to the second transfer transistor TG1 of the second pixel during the first frame to generate a fourth pixel value p270 (see FIGS. 11 and 12, for example). The first, second, third, and fourth pixel values are used to calculate a distance to an object.

According to at least one example embodiment, the first driving circuit controls the plurality of pixels to output color data for the color image in a second frame (see FIG. 12).

According to at least one example embodiment, the first, second, third, and fourth transfer signals have respective phase shifts of 0 degrees, 180 degrees, 90 degrees, and 270 degrees compared to a driving signal of a light source that emits light toward the object.

According to at least one example embodiment, the second driving circuit applies the second transfer signal GD180 to the first transfer transistor TG0 of the first pixel during a second frame to generate a fifth pixel value p180′, applies the first transfer signal GD0 to the second transfer transistor TG1 of the first pixel during the second frame to generate a sixth pixel value p0′, applies the fourth transfer signal GD270 to the first transfer transistor TG0 of the second pixel during the second frame to generate a seventh pixel value p2′70′, and applies the third transfer signal GD90 to the second transfer transistor TG1 of the second pixel during the second frame to generate an eighth pixel value p90′ (see FIGS. 16 and 17).

According to at least one example embodiment, the first, second, third, fourth, fifth, sixth, seventh, and eighth pixel values are used to cancel fixed pattern noise in a distance calculation to the object (see FIG. 25).

According to at least one example embodiment, the first driving circuit and the second driving circuit control the plurality of pixels through a same set of signal lines SL (see FIG. 18, for example).

According to at least one example embodiment, the first driving circuit controls the plurality of pixels to output color data for the color image in a third frame (see FIG. 17).

At least one example embodiment is directed to a system including a light source that emits infrared light, and an imaging device 1 that includes a pixel array including a plurality of pixels 51. Each pixel 51 includes a photoelectric conversion region PD that converts incident light into electric charge, and a first transfer transistor TG0 coupled to a first floating diffusion FD0 and the photoelectric conversion region PD. The imaging device 1 includes a first driving circuit to control the plurality of pixels in an imaging mode to generate a color image based on visible light received from a scene, and a second driving circuit to control the plurality of pixels in a depth mode to generate a depth image based on the infrared light reflected from the scene.

At least one example embodiment is directed to a method that includes driving, by a first driving circuit, a plurality of pixels in an imaging mode to generate a color image, and driving, by a second driving circuit, the plurality of pixels in a depth mode to generate a depth image. The first driving circuit and the second driving circuit drive the plurality of pixels through a same set of signal lines SL.

Any processing devices, control units, processing units, etc. discussed above may correspond to one or many computer processing devices, such as a Field Programmable Gate Array (FPGA), an Application-Specific Integrated Circuit (ASIC), any other type of Integrated Circuit (IC) chip, a collection of IC chips, a microcontroller, a collection of microcontrollers, a microprocessor, Central Processing Unit (CPU), a digital signal processor (DSP) or plurality of microprocessors that are configured to execute the instructions sets stored in memory.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as an embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Example embodiments may be configured according to the following:

(1) An imaging device, comprising:

a pixel array including a plurality of pixels, each pixel including:
a photoelectric conversion region that converts incident light into electric charge; and
a first transfer transistor coupled to a first floating diffusion and the photoelectric conversion region;

a first driving circuit to control the plurality of pixels in an imaging mode to generate a color image; and

a second driving circuit to control the plurality of pixels in a depth mode to generate a depth image.

(2) The imaging device of (1), further comprising:

a plurality of color filters that correspond to the plurality of pixels, wherein the plurality of color filters include red color filters, green color filters, blue color filters, and neutral color filters.

(3) The imaging device of one or more of (1) to (2), wherein the neutral color filters include white color filters, gray color filters, or black color filters.
(4) The imaging device of one or more of (1) to (3), further comprising:

an optical filter on the plurality of color filters and that passes visible light and selected wavelengths of infrared light.

(5) The imaging device of one or more of (1) to (4), wherein the optical filter blocks wavelengths of light between a wavelength of the visible light and a wavelength of the selected wavelengths of infrared light.
(6) The imaging device of one or more of (1) to (5), wherein the second driving circuit applies first, second, third, and fourth transfer signals to the first transfer transistor in first, second, third, and fourth frames, respectively, to generate a first pixel value for the first frame, a second pixel value for the second frame, a third pixel value for the third frame, and a fourth pixel value for the fourth frame, and

wherein the first, second, third, and fourth pixel values are used to calculate a distance to an object.

(7) The imaging device of one or more of (1) to (6), wherein the first, second, third, and fourth transfer signals have respective phase shifts of 0 degrees, 180 degrees, 90 degrees, and 270 degrees compared to a driving signal of a light source that emits light toward the object.
(8) The imaging device of one or more of (1) to (7), wherein the first driving circuit controls the plurality of pixels to output color data for the color image in a fifth frame.
(9) The imaging device of one or more of (1) to (8), wherein the first driving circuit and the second driving circuit control the plurality of pixels through a same set of signal lines.
(10) The imaging device of one or more of (1) to (9), wherein the first driving circuit includes first switching circuitry to connect the set of signal lines to the plurality of pixels in the imaging mode and disconnect the set of signal lines from the plurality of pixels in the depth mode, and wherein the second driving circuit includes second switching circuitry to connect the set of signal lines to the plurality of pixels in the depth mode and to disconnect the set of signal lines from the plurality of pixels in the imaging mode.
(11) The imaging device of one or more of (1) to (10), wherein each pixel further comprises:

a second transfer transistor coupled to a second floating diffusion and the photoelectric conversion region.

(12) The imaging device of one or more of (1) to (11), wherein the second driving circuit applies a first transfer signal to the first transfer transistor of a first pixel during a first frame to generate a first pixel value, applies a second transfer signal to the second transfer transistor of the first pixel during the first frame to generate a second pixel value, applies a third transfer signal to the first transfer transistor of a second pixel during the first frame to generate a third pixel value, and applies a fourth transfer signal to the second transfer transistor of the second pixel during the first frame to generate a fourth pixel value, and

wherein the first, second, third, and fourth pixel values are used to calculate a distance to an object.

(13) The imaging device of one or more of (1) to (12), wherein the first driving circuit controls the plurality of pixels to output color data for the color image in a second frame.
(14) The imaging device of one or more of (1) to (13), wherein the first, second, third, and fourth transfer signals have respective phase shifts of 0 degrees, 180 degrees, 90 degrees, and 270 degrees compared to a driving signal of a light source that emits light toward the object.
(15) The imaging device of one or more of (1) to (14), wherein the second driving circuit applies the second transfer signal to the first transfer transistor of the first pixel during a second frame to generate a fifth pixel value, applies the first transfer signal to the second transfer transistor of the first pixel during the second frame to generate a sixth pixel value, applies the fourth transfer signal to the first transfer transistor of the second pixel during the second frame to generate a seventh pixel value, and applies the third transfer signal to the second transfer transistor of the second pixel during the second frame to generate an eighth pixel value.
(16) The imaging device of one or more of (1) to (15), wherein the first, second, third, fourth, fifth, sixth, seventh, and eighth pixel values are used to cancel fixed pattern noise in a distance calculation to the object.
(17) The imaging device of one or more of (1) to (16), wherein the first driving circuit and the second driving circuit control the plurality of pixels through a same set of signal lines.
(18) The imaging device of one or more of (1) to (17), wherein the first driving circuit controls the plurality of pixels to output color data for the color image in a third frame.
(19) A system, comprising:
a light source that emits infrared light;
an imaging device, comprising:

a pixel array including a plurality of pixels, each pixel including:
a photoelectric conversion region that converts incident light into electric charge; and
a first transfer transistor coupled to a first floating diffusion and the photoelectric conversion region;

a first driving circuit to control the plurality of pixels in an imaging mode to generate a color image based on visible light received from a scene; and

a second driving circuit to control the plurality of pixels in a depth mode to generate a depth image based on the infrared light reflected from the scene.

(20) A method, comprising:

driving, by a first driving circuit, a plurality of pixels in an imaging mode to generate a color image;

driving, by a second driving circuit, the plurality of pixels in a depth mode to generate a depth image, wherein the first driving circuit and the second driving circuit drive the plurality of pixels through a same set of signal lines.

Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

It is claimed:

1. An imaging device, comprising:
a pixel array including a plurality of pixels, each pixel including:
a photoelectric conversion region that converts incident light into electric charge; and
a first transfer transistor coupled to a first floating diffusion and the photoelectric conversion region;
a first driving circuit to control the plurality of pixels in an imaging mode to generate a color image; and
a second driving circuit to control the plurality of pixels in a depth mode to generate a depth image.

2. The imaging device of claim 1, further comprising:
a plurality of color filters that correspond to the plurality of pixels, wherein the plurality of color filters include red color filters, green color filters, blue color filters, and neutral color filters.

3. The imaging device of claim 2, wherein the neutral color filters include white color filters, gray color filters, or black color filters.

4. The imaging device of claim 2, further comprising:
an optical filter on the plurality of color filters and that passes visible light and selected wavelengths of infrared light.

5. The imaging device of claim 4, wherein the optical filter blocks wavelengths of light between a wavelength of the visible light and a wavelength of the selected wavelengths of infrared light.

6. The imaging device of claim 1, wherein the second driving circuit applies first, second, third, and fourth transfer signals to the first transfer transistor in first, second, third, and fourth frames, respectively, to generate a first pixel value for the first frame, a second pixel value for the second frame, a third pixel value for the third frame, and a fourth pixel value for the fourth frame, and
wherein the first, second, third, and fourth pixel values are used to calculate a distance to an object.

7. The imaging device of claim 6, wherein the first, second, third, and fourth transfer signals have respective phase shifts of 0 degrees, 180 degrees, 90 degrees, and 270 degrees compared to a driving signal of a light source that emits light toward the object.

8. The imaging device of claim 6, wherein the first driving circuit controls the plurality of pixels to output color data for the color image in a fifth frame.

9. The imaging device of claim 1, wherein the first driving circuit and the second driving circuit control the plurality of pixels through a same set of signal lines.

10. The imaging device of claim 9, wherein the first driving circuit includes first switching circuitry to connect the set of signal lines to the plurality of pixels in the imaging mode and disconnect the set of signal lines from the plurality of pixels in the depth mode, and wherein the second driving circuit includes second switching circuitry to connect the set of signal lines to the plurality of pixels in the depth mode and to disconnect the set of signal lines from the plurality of pixels in the imaging mode.

11. The imaging device of claim 1, wherein each pixel further comprises:
a second transfer transistor coupled to a second floating diffusion and the photoelectric conversion region.

12. The imaging device of claim 11, wherein the second driving circuit applies a first transfer signal to the first transfer transistor of a first pixel during a first frame to generate a first pixel value, applies a second transfer signal to the second transfer transistor of the first pixel during the first frame to generate a second pixel value, applies a third transfer signal to the first transfer transistor of a second pixel during the first frame to generate a third pixel value, and applies a fourth transfer signal to the second transfer transistor of the second pixel during the first frame to generate a fourth pixel value, and
wherein the first, second, third, and fourth pixel values are used to calculate a distance to an object.

13. The imaging device of claim 12, wherein the first driving circuit controls the plurality of pixels to output color data for the color image in a second frame.

14. The imaging device of claim 12, wherein the first, second, third, and fourth transfer signals have respective phase shifts of 0 degrees, 180 degrees, 90 degrees, and 270 degrees compared to a driving signal of a light source that emits light toward the object.

15. The imaging device of claim 14, wherein the second driving circuit applies the second transfer signal to the first transfer transistor of the first pixel during a second frame to generate a fifth pixel value, applies the first transfer signal to the second transfer transistor of the first pixel during the second frame to generate a sixth pixel value, applies the fourth transfer signal to the first transfer transistor of the second pixel during the second frame to generate a seventh pixel value, and applies the third transfer signal to the second transfer transistor of the second pixel during the second frame to generate an eighth pixel value.

16. The imaging device of claim 15, wherein the first, second, third, fourth, fifth, sixth, seventh, and eighth pixel values are used to cancel fixed pattern noise in a distance calculation to the object.

17. The imaging device of claim 15, wherein the first driving circuit and the second driving circuit control the plurality of pixels through a same set of signal lines.

18. The imaging device of claim 15, wherein the first driving circuit controls the plurality of pixels to output color data for the color image in a third frame.

19. A system, comprising:
a light source that emits infrared light;
an imaging device, comprising:
a pixel array including a plurality of pixels, each pixel including:
a photoelectric conversion region that converts incident light into electric charge; and
a first transfer transistor coupled to a first floating diffusion and the photoelectric conversion region;
a first driving circuit to control the plurality of pixels in an imaging mode to generate a color image based on visible light received from a scene; and
a second driving circuit to control the plurality of pixels in a depth mode to generate a depth image based on the infrared light reflected from the scene.

20. A method, comprising:
driving, by a first driving circuit, a plurality of pixels in an imaging mode to generate a color image;
driving, by a second driving circuit, the plurality of pixels in a depth mode to generate a depth image, wherein the first driving circuit and the second driving circuit drive the plurality of pixels through a same set of signal lines.
